(19) United States
(12) Patent Application Publication
(10) Pub. No.: US 2011/0182155 A1
(43) Pub. Date: Jul. 28, 2011

(54) System and method for remote access of optical disc media

(75) Inventor: Paul Heitlinger, Short Hills, NJ (US)

(73) Assignee: S1DIGITAL, LLC, Rochelle Park, NJ (US)

(21) Appl. No.: 12/656,392

(22) Filed: Jan. 28, 2010

(51) Int. Cl. G11B 21/08

(52) U.S. Cl. 369/30.26; G9B/21.012

(57) ABSTRACT

A system and method to remotely access optical disc media over a network. The present invention provides the benefits of consolidated storage of media and remote access, while maintaining an exclusive playback policy and allowing access to optical multimedia stored on remotely stored optical discs in accordance with the playback policy. The present invention provides a solution to those seeking to remotely access multimedia stored on optical discs from remote locations, particularly in situations that require direct hardware access to properly read the data from optical disc drives.

### BACKGROUND OF THE INVENTION

1. Field of the Invention

This invention relates generally to a system and method for remote access of optical disc media and, particularly, to a system and method for selecting and accessing optical discs in a remote disc drive.

2. Description of the Related Art

Optical discs are the primary media by which multimedia (e.g., music, video, commentary, etc.), data and software are distributed to consumers. Optical discs most commonly take the form of CDs, DVDs, HD-DVDs, and Blu-Ray Discs, and may contain any combination of music, video, data, and software. Consumers wanting to access media contained in such optical discs can employ stand-alone optical disc players (e.g., such as a CD, DVD, HD-DVD, or Blu-ray players) or computers equipped with appropriate optical disc devices (ODD).

FIG. 1 illustrates a conventional computer system 1 equipped to play media from an optical disc. The computer system includes a personal computer 15 connected to a monitor 20. Computer 15 is also connected to an optical disc drive (ODD) 10. ODD 10 is capable of storing and playing media from an optical disc (e.g., CD, DVD, HD-DVD, Blu-Ray Disc, etc.). ODD 10 may be either a peripheral of computer 15, connected via a serial cable, such as a USB, or may be an internal component of computer 15 connected via, for example, an IDE or SATA cable. Monitor 20 provides a user interface display to computer 15. The user interface allows a user to interact with computer 15 and playback media for an optical disc in ODD 10.

Commercially distributed media is often protected using some effective copy protection schemes and by international copyright law. For example, common protection schemes employed in optical discs include CSS encryption, HCSS encryption, BD+, H_BD+, and A-KOS. The Digital Millennium Copyright Act (DMCA) makes it illegal to circumvent such copy protection schemes in order to extract the contents of a copy protected optical disc. Furthermore, the copyright license granted by the purchase of the media often limits the distribution and viewing rights of the purchaser.

Consumers can playback media from commercial optical discs using commercially available media playback software that employs legally distributed decryption components for playback of media from optical discs. However, this software generally limits playback of the media to viewing of that physical media and prevents the copy and storage of the media. Therefore, the software does not provide for a mechanism to access the media, except to playback the optical disc in the playback software. Furthermore, the playback software often must have direct access to the ODD driver, since the encryption schemes employed prevent regular read operations by computer 15 without the decryption components from the playback software. Therefore, the sharing of data from physical media imposes numerous challenges since playback requires direct access to the hardware driver on computer 15 to which the ODD is physically connected.

In a network environment, an alternative may include having a server computer share a physically connected optical disc drive with a client computer via a network. However, this approach fails to provide the necessary direct driver access required for playback of the contents of commercial optical discs, since the requesting computer cannot access a remote shared drive at the same hardware level as a physically connected computer. This is because a shared drive is not read by the remote computer directly, but is instead read by the operating system of the server and then transmitted to the client. Thus, with most optical media, playback of the multimedia may be impossible from a remote location using standard drive sharing.

Another option is to extract the media from the optical disc onto a shared hard drive. FIG. 2 illustrates a conventional digital media distribution system 2, whereby multimedia is stored on a media storage database 25. Digital media distribution system 2 includes a client computer 40 connected to media server 30 via network 35. Media server 30 is connected to media storage database 25, which contains multiple various multimedia titles which have been extracted from optical discs or obtained by other means. Client computer 40 includes software for viewing and selecting media from media storage database 25 at client computer 40. In order to access media server 30, client computer 40 may need to employ special software to prevent long-term storage of multimedia from media storage database 25. Media server 30 acts as a gateway or interface to media storage database 25, whereby media server 30 monitors and encrypts communications to client 40, to ensure that client 40 only views the multimedia from media storage database 25 via a specific application, and cannot store the transmitted multimedia. Alternatively, the user of client computer 40 may obtain copies of multimedia through media server 30 by purchasing a copy of a given media title from media storage database 25.

There are numerous benefits to the distribution of media over networks, since it provides quick access and transportability to purchased media with a limitless inventory. However, the purchasing and viewing of digital media without a physical medium also suffers from a series of problems. For example, purchasing a digital-only media denies the consumer access to a physical disc, may not provide the same fidelity, and is subject to complex ownership rules. Furthermore, the absence of a physical medium denies consumers the feeling of substantial ownership and provides less intuitive ownership rights. Finally, digital-only media can sometimes be duplicated and distributed illegally.

In the case of non-commercial distribution, sharing and remote access of digital media by consumers often includes the breaking of copyright protection and thereby violation of the Digital Millennium Copyright Act (DMCA). For example, a user seeking to make a movie available for remote viewing, even for personal use, must extract the media from the optical disc to a hard-drive; a process referred to as “ripping.” The user may then make the multimedia available on the server for remote playback via streaming or copying.

Ripping commonly refer to the digital extraction of audio or video content to a hard disc from removable media, such as an optical disc. While it is, generally, legal for an individual to copy media one owns for personal use, as explained above, widely distributed media is often protected using some effective copy protection schemes. Ripping circumvents these copy protection schemes in order to extract the contents of a copy protected optical disc; thus making it illegal to rip most commercial optical discs.

Accordingly, there is a conflict between the desire for and benefit of physical media versus the convenience of digital data ownership. There also exists a need for a consolidated disc management mechanism that provides the benefits of physical disc media ownership with the convenience of digital data ownership.

### SUMMARY OF THE INVENTION

The present invention provides the benefits of consolidated storage of media and remote access while maintaining an exclusive playback policy and allowing such access to optical multimedia stored on remotely stored optical discs. The present invention also provides a solution to consumers seeking to remotely access multimedia stored on optical discs from remote locations, particularly in situations that require direct hardware access to optical disc drives.

At least one embodiment of the present invention allows users to access optical discs that are in optical disc drives that are physically connected to a remote server by enabling network access to the optical disc device connected to the server using a paradigm that limits clients to exclusive, one-at-time access any given optical disc.

A first example embodiment may include a system for accessing multimedia from a remote location. The system may include an optical disc drive which may contain an optical multimedia disc, a multimedia server, a multimedia client, and a network that connects the server and client.

The disc drive may be a single disc drive, a multi-disc changer which may include a plurality of optical discs, or the system may employ a plurality of optical disc drives that may include any combination of single disc drives and multi-disc changers.

The multimedia server may be connected directly to the optical disc drive or the multimedia server may include the optical disc drive as an internally installed component. The multimedia server may also include a cataloguing component, catalogue storage medium, drive state component, and device server. The multimedia catalogue may include multimedia information identifying the multimedia in the optical disc drive. For example, the catalogue may include titles, images, tracks, chapters, or any other content descriptions that may be relevant to help a user to select between multimedia within the disc drive. The drive state component may control access to the optical disc drive and determine whether the optical disc drive is in a locked state or an available state, where the locked state indicates that the optical disc drive is locked for exclusive use by a client. For example, the drive state component may lock the optical disc drive for exclusive use by a client when a user of that client selects multimedia from the multimedia catalogue corresponding to the optical disc in the optical disc drive. Conversely, the drive state component may unlock the optical disc drive for exclusive use by the client when a playback component at the client stops playing the selected multimedia data. The cataloging component may monitor the optical disc drive and maintain a multimedia catalogue. Maintaining the multimedia catalogue may include updating the multimedia catalogue and providing the multimedia catalogue to a client. For example, when the user selects multimedia from the multimedia catalogue corresponding to the optical disc in the optical disc drive, the cataloguing component may disable selection of the multimedia, within the optical disc drive, by a second client. Conversely, when the playback component stops playing the selected multimedia, the cataloguing component may enable selection of the multimedia, within the optical disc drive, by a second client. Finally, the device server may provide the client direct access to the optical disc drive when the drive state component locks the optical disc drive for exclusive use by the client.

The multimedia client may include a network interface, a user interface, a playback component, and a remote access client. The network interface may allow the client to request the multimedia catalogue from the server. The user interface may then allow a user to select multimedia from the multimedia catalogue and display the multimedia. The playback component may serve to play selected multimedia at the client. Finally, the remote access client may allow the multimedia playback component to directly access the optical disc drive at the server. For example, the remote access client may communicate with the device server to transmit read operation commands to the optical disc drive and receive read operation output from the optical disc drive.

A second example embodiment may include a method for playing media from a remote location. The method may include monitoring multimedia in an optical disc in an optical disc drive, updating a multimedia catalog to identify the multimedia on the optical disc, providing the multimedia catalogue to a client, controlling access to the optical disc drive by locking the optical disc drive for exclusive use by the client, and providing the client direct access to the optical disc drive, when the optical disc drive state component locks the optical disc drive for exclusive use by the client.

The second example embodiment may further include requesting the multimedia catalogue from the server, displaying the multimedia catalogue at a client, selecting multimedia from the multimedia catalogue at a client, and playing the contents of the selected multimedia data using a playback component at a client. The playback component may directly access the optical disc drive, connected to the server, using a remote access driver.

### BRIEF DESCRIPTION OF THE DRAWINGS

These and other more detailed and specific features of the present invention are more fully disclosed in the following specification, reference being had to the accompanying drawings, in which:

FIG. 1 illustrates a conventional computer system equipped with an optical disc drive.

FIG. 2 illustrates a conventional digital media distribution system.

FIG. 3 illustrates an example embodiment of an optical media distribution system.

FIGS. 4A and 4B illustrate example embodiments of the components of a server and a client.

FIG. 5 illustrates an alternative example embodiment of an optical media distribution system.

FIG. 6 illustrates an example process performed by an example embodiment when an optical disc is inserted into a disc drive.

FIG. 7 illustrates an example process performed by an example embodiment when an optical disc is removed from a disc drive.

FIG. 8 illustrates an example process performed by a client for playing multimedia from an optical disc in a remote optical disc drive.

FIG. 9 illustrates an example process for polling requests performed by a server.

FIG. 10 illustrates an example embodiment of a user interface.

FIG. 11 illustrates an alternative example embodiment of a user interface.

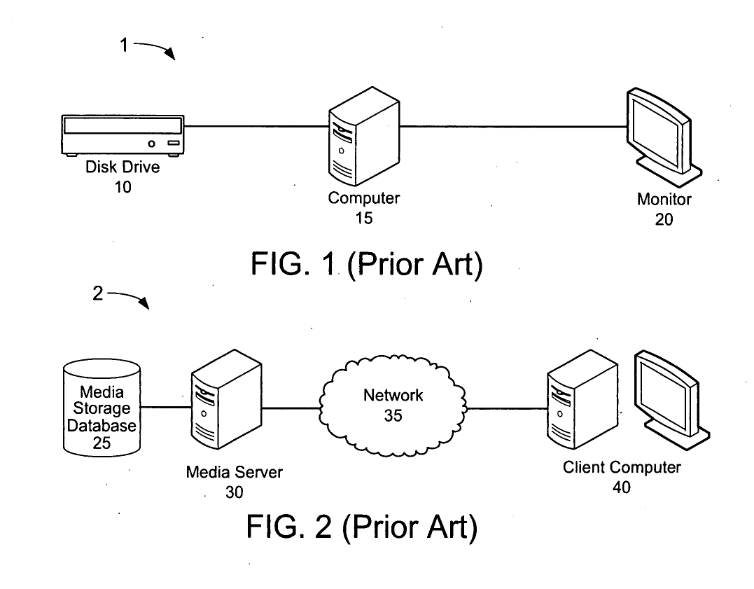

### DETAILED DESCRIPTION OF THE INVENTION

In the following description, for purposes of explanation, numerous details are set forth, such as flowcharts, system configurations, and processing architectures in order to provide an understanding of one or more embodiments of the present invention. However, it is and will be apparent to one skilled in the art that these specific details are not required in order to practice the present invention.

The present invention provides the benefits of optical disc storage and remote access while maintaining an exclusive playback policy by allowing access to multimedia stored on remote optical discs. The present invention also provides a solution to consumers seeking to remotely access multimedia stored on optical discs from remote locations, particularly, in a situation that requires direct driver access to an optical disc drive (“ODD”) containing the desired multimedia.

An example embodiment may allow users to access optical disc drives that are physically connected to a remote server by providing direct access to an ODD connected to a server. Providing direct access to the ODD allows a client computer to communicate with a remote ODD as if the remote ODD were physically attached to the client. This allows the client to process the ODD output (e.g., decrypt and playback the media within the ODD) as if the ODD were directly connected to the client.

While accessing the ODD, a client is given exclusive access to the ODD. This ensures that clients only access the optical discs located in the optical disc device at the server on an exclusive, one-at-a-time basis. As such, only a single client is capable of playing media from a given ODD at-a-time. However, many users can access the multimedia data on the optical discs through the network in this fashion. Furthermore, the data transmitted from the server, connected by the ODD, to the client remains encrypted until the client decrypts the data using playback software that is legally licensed to decrypt and playback the media from an optical disc in the ODD.

The following component diagrams, exemplary hardware and software embodiments described herein need not be arranged in any particular order. Furthermore, it is noted that while the foregoing figures provide exemplary implementations with respect to various hardware or software components, the provided embodiments are only exemplary and do not limit the scope of the invention to any specific implementation or architecture. For example, the disclosed components can be merged into a single component or further subdivided while remaining within the scope of the invention.

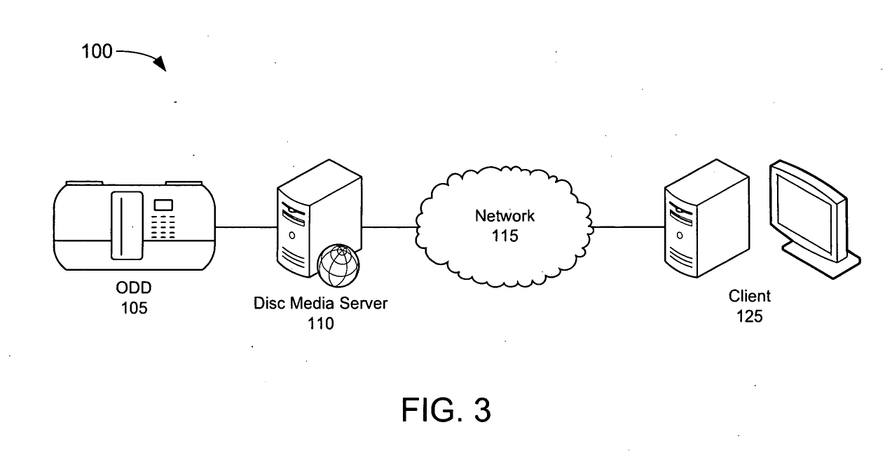

FIG. 3 illustrates an example embodiment of an Optical Media Distribution System 100.

Optical Media Distribution System 100 may include Disc Media Server 110, Optical Disc Device (ODD) 105, and client 125. ODD 105 may be a peripheral device of Disc Media Server 110. Disc Media Server 110 may be connected to ODD 105 via a serial bus, parallel port, firewire, wireless link or any other mechanism for transferring data between Disc Media Server 110 and ODD 105. Alternatively, ODD 105 may be an internal component of Disc Media Server 110. Disc Media Server 110 may be connected to a network 115 and may communicate with client 125 via network 115. Network 115 may be the Internet, a WAN, a LAN, a cellular network, or any other network capable of transferring data between client 125 and Disc Media Server 110.

ODD 105 may be an optical disc changer (e.g., a carousel) containing multiple discs. Alternatively, ODD 105 may be a single disc drive or any other device for storage and playback of optical discs.

Client 125 may be, for example, a personal computer and may include any peripherals necessary to use the personal computer (e.g., a monitor, keyboard, mouse, etc.). Alternatively, client 125 may be a laptop, smartphone, CE device (e.g. set top box network-enabled television, television with a network-enabled cable box, etc.), or other device capable of communicating with Disc Media Server 110 over network 115.

Disc Media Server 110 may maintain a media library catalog that identifies the contents of the media stored on the optical discs within ODD 105. Upon connecting to ODD 105, Disc Media Server 110 may communicate with ODD 105 and generate the media library catalog based on the media contained within ODD 105. When an optical disc is inserted into ODD 105, the media library catalog may be expanded or updated to include any additional media in the optical disc added to ODD 105. Conversely, when an optical disc is removed from ODD 105, the media contained in the optical disc may be removed from the media library catalog.

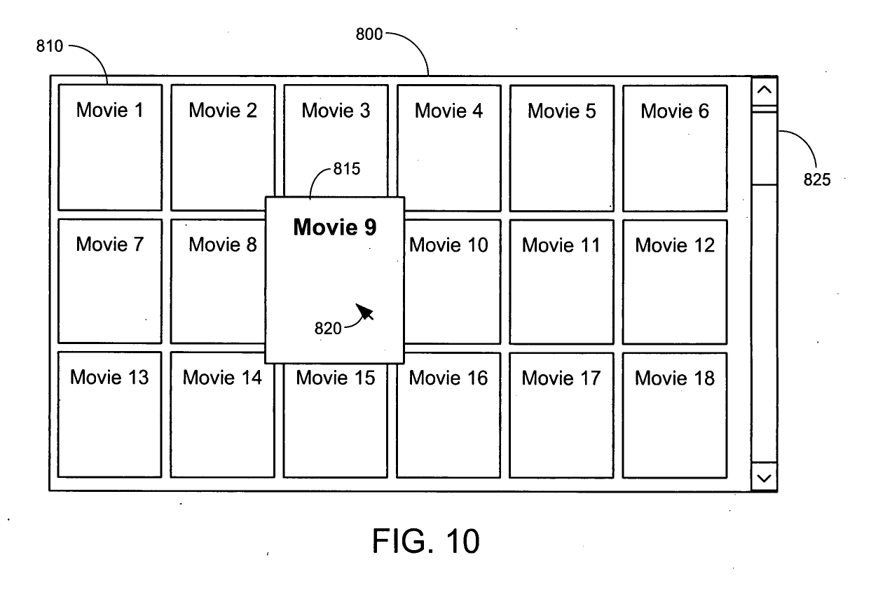

A user at client 125 may, initially, activate a media library client application for browsing the contents of the media library catalog. Upon initialization, the client application may request and receive the media library catalog from Disc Media Server 110. The client application may then display the media library catalog to the user in a interface, and allow the user to select media from the media library catalog for playback at client 125 (see FIG. 10). The browseable interface may, for example, display the various titles of the media in the media library catalog and allow the user to scroll and select from the various titles. For example, the interface may provide a catalog of movies and/or audio media which may be sorted using pre-defined or customized criteria. Alternatively or furthermore, the client application may allow the user to search or query for specific media based on title, genre, artist, etc.

When the user selects the media form the media library catalog, Disc Media Server 110 may provide client 125 with access to optical discs contained within ODD 105. More specifically, when a user selects a given media, the client 125 notifies Disc Media Server 110 of the selection through network 115. The Disc Media Server 110 may then identify the ODD 105 in which the selected media is stored. Disc Media Server 110 may then lock ODD 105 for exclusive use by client 125.

Once ODD 105 is locked for exclusive use by client 125, Disc Media Server 110 loads a device share server and client 125 loads a device share client, which provides a direct connection between client 125 and ODD 105. This direct connection allows Disc Media Server 110 to transfer the selected media contained in the optical disc in ODD 105 to client 125. This connection allows client 125 to operate ODD 105 similarly to a physically connected device. For example, data read by ODD 105 may be transmitted to client 125 in an unformatted or encrypted form without processing by the operating system of Disc Media Server 110.

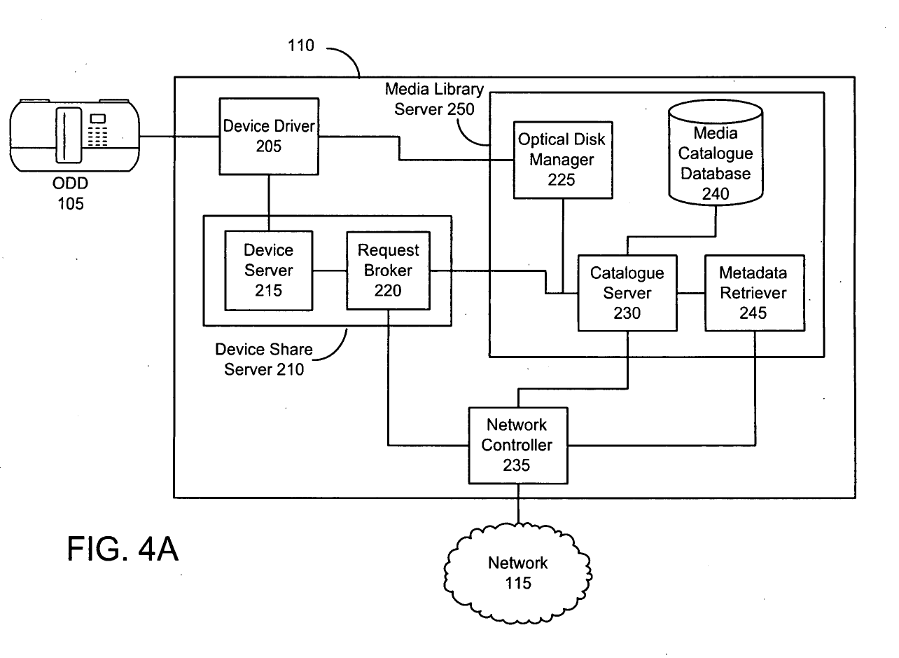

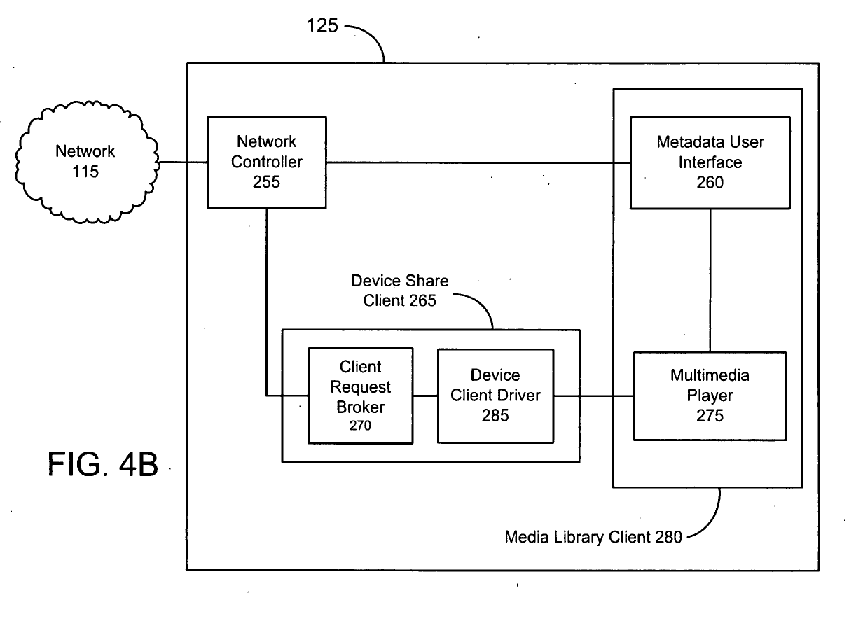

FIGS. 4A and 4B illustrate example embodiments of the components of Disc Media Server 110 and client 125, respectively.

FIG. 4A illustrates an example embodiment of the components of Disc Media Server 110. Similarly to FIG. 3, Disc Media Server 110 is connected to ODD 105 and network 115. Disc Media Server 110 may include Device Driver 205, Device Share Server 210, Media Library Server 250, and Network Controller 235.

Media Library Server 250 may monitor the contents of ODD 105, maintain the media catalogue, and provides client 125 with access to the media library catalogue. Media library server 250 includes Optical Disc Manager 225, Catalog Server 230, Media Catalog Database 240, and Metadata Retriever 245.

Optical Disc Manager 225 may monitor the optical discs stored in ODD 105 and notify Catalog Server 230 of any changes in the optical discs stored in ODD 105. For example, if an optical disc is added to ODD 105 then optical disc manager 225 may notify Catalog Server 230. Similarly, if an optical disc is removed from ODD 105, Optical Disc Manager 225 may notify Catalog Server 230. In response to the notification from Optical Disc Manager 255, Catalog Server 230 may generate or update the media library catalogue to account for the added or removed optical discs from ODD 105. Catalog Server 230 may also store the generated media library catalogue in Media Catalogue Database 240.

While Media Catalogue Database 240 is illustrated as a component of Disc Media Server 110, Media Catalogue Database 240 may also be stored externally on a separate server or at a remote location. Media Catalogue Database 240 may be any form of database, including, but not limited to, a hierarchical database, a set of files in a file system, an application database in a proprietary format, a relational database management system (RDBMS), etc.

Catalog Server 230 may communicate with Metadata Retriever 245 to obtain identification information for the multimedia stored in ODD 105. For example, audio media in ODD 105 may be cataloged by Catalog Server 230, which may employ Metadata Retriever 245 to retrieve title, track, album, and artist information associated with the audio media, for the media library catalogue. Metadata Retriever 245 may communicate with various external databases for audio data (e.g., a proprietary database, CDDB, gracenote, Amazon, etc.). Similarly, Catalog Server 230 may also catalog movies stored in the optical discs in ODD 105 and employ Metadata Retriever 245 to retrieve title, actor, director, and genre, or other information associated with the movie related to the media library catalogue. Metadata Retriever 245 may communicate with various external databases to retrieve movie information (e.g. a proprietary database, IMDB. Amazon, etc.).

Device Share Server 215 may provide client 125 with exclusive access to ODD 105 when ODD 105 is locked for use by client 125. Device Share Server 210 may include Device Server 215 and Request Broker 220. Request Broker 220 may monitor any incoming access requests to ODD 105 from external clients, such as client 125, and ensures that only a designated client 125 may access the ODD 105 when the ODD is locked. If an incoming request comes from the designated client 125, the Request Broker 220 may pass the request to Device Server 215. Alternatively, if an incoming request does not originate from the designated client 125, the Request Broker 220 may reject or drop the request. Device Server 215 may function as a local proxy for communication between Client 125 and Device Driver 205, and thereby allow Client 125 to transmit hardware instructions and receive unformatted, encrypted output from ODD 105 via Device Driver 205.

For example, when a Media Library Client requests the media library catalogue from Disc Media Server 110, the request may enter Disc Media Server 110 through network 115 at Network Controller 235. Network Controller 235 may route the request to Catalog Server 230. Catalog Server 230 may obtain the media library catalogue from Media Catalogue Database 240 and transmit the catalog to Network Controller 235, which may transmit the media library catalogue to client 125 via network 115. After the user selects a given media, such as a movie, from the media library catalogue, a playback request may be transmitted to Catalog Server 230. Catalog Server 230 may confirm that the multimedia is available for playback, and transmit the request to Request Broker 220. Request Broker 220 may determine that ODD 105 is available for exclusive playback and then lock ODD 105 for exclusive playback by client 125. Catalog Server 230 may then notify client 125 that ODD 105 is locked and available for exclusive use by client 125. Thereafter, client 125 may begin to access ODD 105 through Device Share Server 210.

Communications between client 125 and ODD 105 may pass through network 115 to Network Controller 235. Network Controller 235 may route the request to Request Broker 220 which confirms that the communication comes from client 125, and thereafter forwards the request to Device Server 215. Device Server 225 may communicate with Device Driver 205 to operate ODD 105. During playback, client 125 may transmit hardware control and read requests to ODD 105 and receive output data from ODD 105. However, Device Server 225 may limit the hardware control and read requests which client 125 may provide ODD 105. For example, Device Server 225 may filter communications from the client 125 to only allow instructions for reading media, or even for reading only particular media on a specific optical disc. Alternatively, Request Broker 220 may filter requests from client 125 to only a subset of the possible control and read operations available, or may limit the requests to a particular media in ODD 105.

When the user has finished playback of the selected media, client 125 may notify the Request Broker 220 or may notify the Catalog Server 230, which may notify the Request Broker 220. In response, Request Broker 220 may then unlock ODD 105 from the exclusive use state and notify Catalog Server 230 that ODD 105 (and the media in ODD 105) is available for playback by any client. In response to the notification, Catalog Server 230 may flag the media located on optical discs in ODD 105 as selectable for playback by any client 125.

FIG. 4B illustrates an example embodiment of the components of client 125. Client 125 may include Network Controller 255, Device Share Client 265, and Media Library Client 280.

Media Library Client 280 may include Metadata User Interface 260 and Multimedia Player 275. Metadata User Interface 260 provides a user of client 125 with an interface to the media library catalogue from Disc Media Server 110. Multimedia Player 275 may play media contained in ODD 105.

Device Share Client 265 includes Client Request Broker 270 and Device Client Driver 285. The user of client 125 may use Metadata User Interface 260 to browse and select media from the Media Library Catalogue stored on the Disc Media Server 110. Upon initialization, Metadata User Interface 260 may request the media library catalogue from Disc Media Server 110 via Network Controller 255. Upon receiving the media library catalogue, the user may select from the media in the Media Library Catalogue. Thereafter, Metadata User Interface 260 may request access to ODD 105, containing the selected media. Upon receiving confirmation from the Disc Media Server 110 that ODD 105 is set for exclusive use by client 125, Metadata User Interface 260 may load Multimedia Player 275 to play the user-selected media. Furthermore or alternatively, upon receiving confirmation of exclusive use from the Disc Media Server 110, Metadata User Interface 260 may load Device Share Client 265 or enable Device Share Client 265.

Multimedia Player 275 may access media from optical discs on ODD 105 by employing Device Share Client 265. Device Share Client 265 may operate and install into Client 125 similarly to a device driver for a physically connected optical disc device. Therefore, Multimedia Player 275 may communicate and access optical discs contained in ODD 105 using similar instructions and operations used to play media from a physically connected drive.

Device Share Client 265 includes Device Client Driver 285 and Client Request Broker 270. Device Client Driver 285 may capture hardware access commands from client 125. These hardware access commands may be transmitted via Network Controller 255 and network 115 to Disc Media Server 110, Disc Media Server 110 may route the hardware commands to ODD 105. This allows client 125 to operate ODD 105 as though it were a local peripheral. Client Request Broker 270 may manage the state of ODD 105, with respect to client 125. As such, Client Request Broker 270 will only transmit hardware access commands to Disc Media Server 110 if ODD 105 is the designated client granted exclusive use of ODD 105. Alternatively, Client Request Broker 270 may disable Device Client Driver 285 or Device Share Client 265, when ODD 105 is locked for exclusive use by another client 125.

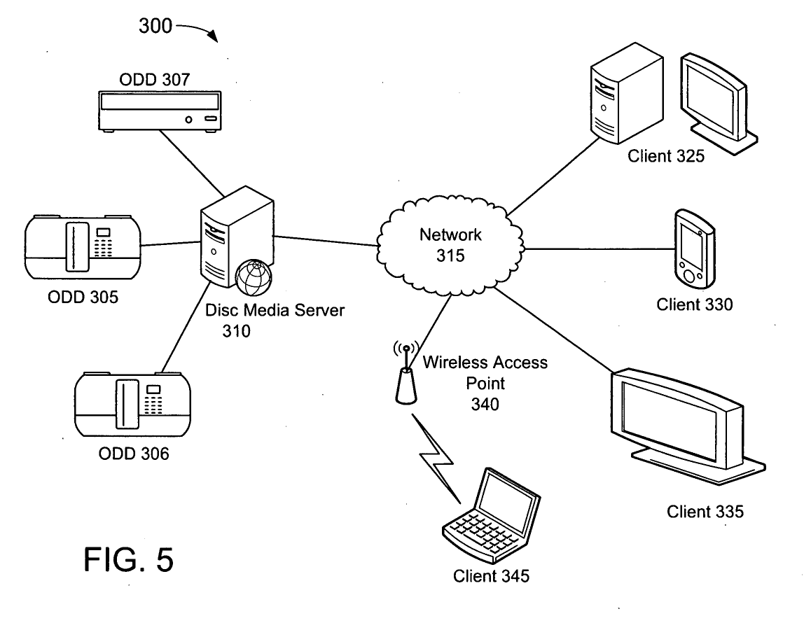

FIG. 5 illustrates an example embodiment of an Optical Media Distribution System 300. Media distribution system 300 may include a Disc Media Server 310, which is connected to multiple optical disc drives, including ODD 305, ODD 306, and ODD 307. In this example embodiment, ODD 305 and ODD 306 may be multi-disc changers (e.g., carousels); while optical disc drive 307 may be a single disc optical disc drive. In Media Distribution System 300, Disc Media Server 310 may be connected to various different types of optical disc drive devices. Disc Media Server 310 may connect to network 315 and thereby to clients to 325, 330, 335, and 345; client 325 may be a personal computer, client 330 may be a cell phone or smartphone, client 335 may be a network-enabled television or set-top box, and 345 may be a laptop communicating via a wireless access point 340. Further clients may communicate with Disc Media Server 310 via network 315 or via other known methods or alternative networks.

By example, during operation, a user of client 325 may select to play media from an optical disc in ODD 305. In response, Disc Media Server 310 may lock ODD 305 for exclusive use by client 325. While ODD 305 is locked for exclusive user by client 325, Disc Media Server 310 may disable the capacity for clients 325, 330, 335, and 345 to select from media stored on any optical disc in ODD 305. For example, Disc Media Server 310 may set a flag in the media catalog that indicates that the optical discs in ODD 305 are unavailable. Alternatively, Disc Media Server 310 may set a plurality of flags in the media catalog to indicate the media that is unavailable. Accordingly, any response by the media catalog Disc Media Server 310 from the clients 325, 330, 335, and 345 for the media library catalog may indicate that the media in ODD 305 is unavailable, and therefore not selectable. Furthermore, any request to access or use ODD 305 by any client, other than client 325, will be denied.

The following processes, flow charts, figures, diagrams, functions, steps and/or actions in the provided embodiments of the invention described herein need not be performed in any particular order. Furthermore, it is noted that while the foregoing processes are described with respect to various hardware or software components, the provided embodiment is only exemplary and does not limit the scope of the invention to any specific implementation or architecture.

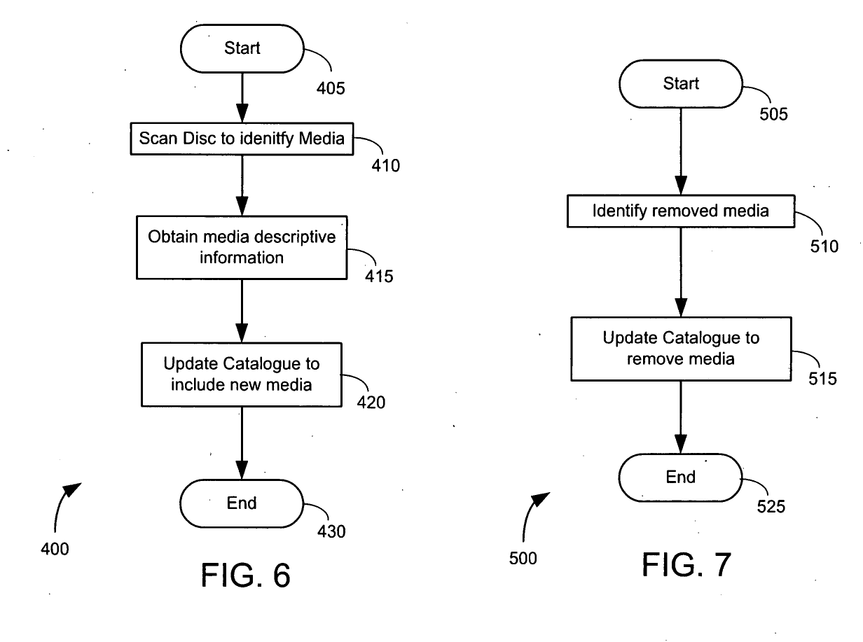

FIG. 6 illustrates an Optical Disc Addition Process 400 performed by Disc Media Server 110 when an optical disc is inserted into ODD 105. While the disclosed process is discussed with reference to Disc Media Server 110, process 400 is applicable to alternative embodiments, such as Disc Media Server 310. Furthermore, process 400 may be performed or managed by Catalog Server 230 in response to a notification that an optical disc has been inserted into ODD 105; such a notification may be provided by Optical Disc Manager 225, which may monitor ODD 105 to detect the removal and insertion of optical discs.

The Optical Disc Addition Process 400 starts, at step 405, when an optical disc is inserted into ODD 105.

At step 410, the inserted optical disc is scanned to identify the different digital media contained within the optical disc. For example, if the inserted optical disc is a DVD, step 410 may include identifying the main title in the DVD and the various sub-titles, chapters, and extra features in the DVD. Alternatively, if the inserted optical disc is an audio CD, step 410 may include identifying the music digital media and any extra features contained in the optical disc.

Step 410 may also include determining a unique identifier for the optical disc. This unique identifier may be located in or on the optical disc or may be determined using a calculation based on the media stored on the optical disc. For example, the calculation may include a checksum or hash based on information from the optical disc. This calculation may employ the various files, file sizes, file structures, number of files, or any other data that can be obtained from the optical discs. Furthermore, different techniques may be used to determine the unique identifier for different types of optical media. For example, the unique identifier for CDs may be calculated using a different calculation than that used for DVDs. Furthermore, the unique identifiers may be distinct in structure between different types of optical media.

Next, at step 415, Disc Media Server 110 may obtain descriptive information to associate with the digital media on the inserted optical disc. For example, if the optical disc is a DVD, the descriptive information may include the main movie title, the chapter titles, titles for the extra features, cover art, etc. The descriptive information may be obtained by analyzing the digital media on the optical disc and may also include querying external resources. For example, this may include communicating with such databases as CDDB, Amazon, IMDB, or any other available public and private resources for identifying and cataloging media within the optical disc. By reference to FIG. 4A, step 415 may be performed by Metadata Retriever 245 in response to a request from Catalog Server 230. Once the available descriptive information has been retrieved, process 400 may continue to step 420.

At step 420, the media library catalog is updated with the media descriptive information obtained in step 415, which is stored in catalog storage database 240. Thereafter, the process ends at step 430.

FIG. 7 illustrates an Optical Disc Removal Process 500 performed by Catalog Server 230 in response to the removal of an optical disc from ODD 105. While the disclosed process 500 is discussed with reference to Disc Media Server 110, process 500 is applicable to alternative embodiments, such as Disc Media Server 310. By example, process 500 may be performed or managed by Catalog Server 230 in response to a notification that an optical disc has been removed from ODD 105; such a notification may be provided by Optical Disc Manager 225, which may monitor ODD 105 for the insertion and removal of optical discs.

Process 500 may be performed by Disc Media Server 110 when an optical disc is removed from ODD 105. By example, Optical Disc Manager 225 may monitor ODD 105 and notify Catalog Server 230 that an optical disc has been removed from the ODD 105. The Optical Disc Removal Process 500 starts at step 505, when an optical disc is removed from ODD 105.

At step 510, Disc Media Server 110 may identify the removed optical discs and identify the media associated with the removed optical disc. Disc Media Server 110 may then update the media library catalog to remove any media titles in the media library catalog associated with the removed optical disc. Within Disc Media Server 110, the optical disc manager may notify the Catalog Server 230 that a disc has been removed, and provide Catalog Server 230 with the identity of the removed disc.

At step 515, the Disc Media Server 110 may store the updates to the media library catalog into media catalogue database 540. Within Disc Media Server 110, the Catalog Server 230 may identify the media associated with the removed optical disc and delete them from the media library catalog.

Thereafter, the process may end at step 525.

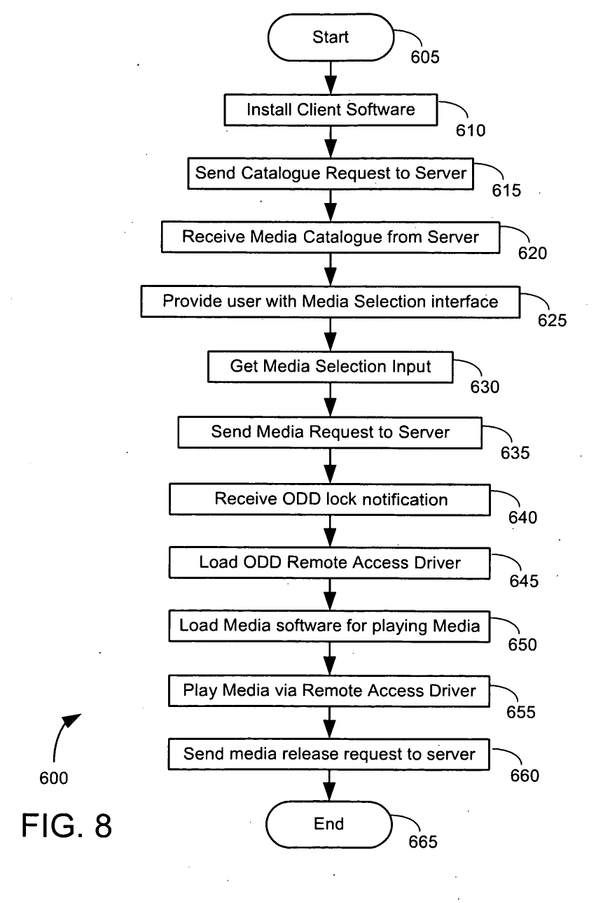

FIG. 8 illustrates a Media Playback Process 600 performed by client 125 to play multimedia on an optical disc in ODD 105.

The process starts at step 605. Initially, at step 610, a user may be required to install client software on client 125. This software may include the installation of the Media Library Client 280 which may include the Metadata User Interface 260 and the Multimedia Player 275. This may also include installation of the Device Share Client 265 which may be installed and operate similarly to a device driver. The installation of Device Share Client 265 may allow client 125 to operate ODD 105 similarly to a local physical optical disc drive.

In various alternative embodiments, step 610 may not exist. Some devices may come pre-loaded with the necessary software to execute the steps performed by the Media Library Client 280 and Device Share Client 265. For example, if the client is a CE device, the client may come pre-configured with components to operate as Media Library Client 280 and Device Share Client 265.

At step 615, a user may initialize Metadata User Interface 260 or activate of Metadata User Interface 260 software. Metadata User Interface 260 may automatically request the media library catalog from Disc Media Server 110. Alternatively, Metadata User Interface 260 may query the network for an available Disc Media Server 110, and allow the user to select an available Disc Media Server 110 from a list of available servers. Then, the Metadata User Interface 260 may allow the user to request a media catalog from the selected Disc Media Server 110 or may automatically request a media library catalog from the selected Disc Media Server 110. Within Disc Media Server 110, Catalog Server 230 may receive the request for the media library catalog from client 125, and respond by transmitting the contents of the media library catalog to client 125.

At step 620, client 125 may receive the media library catalog from Disc Media Server 110.

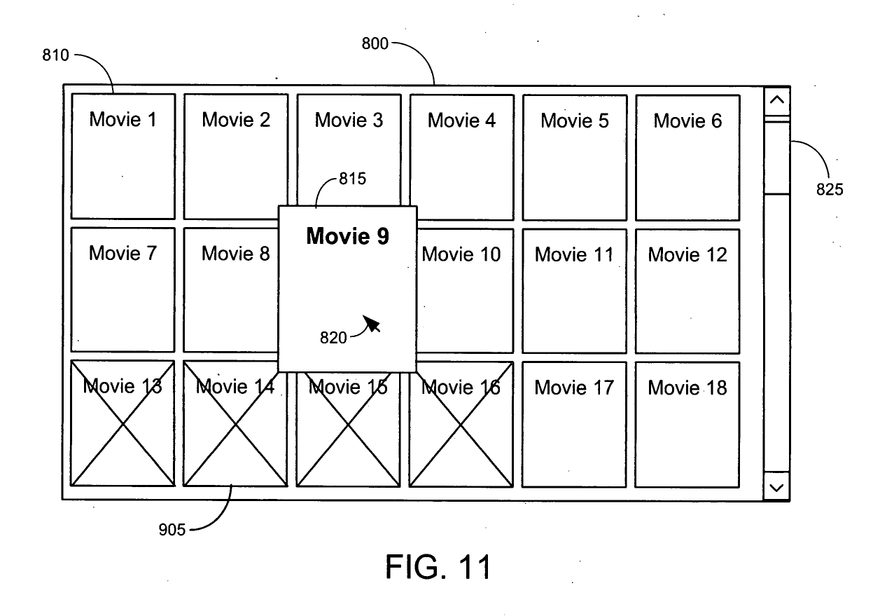

At step 625, the Metadata User Interface 260 may provide the user with a media selection interface. The media selection interface is described below with respect to FIGS. 10 and 11.

At step 630, client 125 may receive input from the user selecting a given media from the media library catalog displayed by the Metadata User Interface 260. This results in the generation of media requests to server 110, at step 635.

Upon receiving the media request from client 125, the Disc Media Server 110 may lock ODD 105 for exclusive use by client 125. Within Disc Media Server 110, the media request may be received by the Catalog Server 230 which may transmit the request to the Request Broker 220. Then, the Catalog Server 230 or Request Broker 220 may transmit an ODD lock notification to client 125, indicating that ODD 105 is locked for exclusive use by client 125.

At step 640, client 125 may receive the ODD lock notification and proceed to step 645.

At step 645, the client 125 may load or enable Device Share Client 265. This allows the client 125 to access the media in ODD 105 similarly to a physically connected disc drive.

At step 650, the client may load the media software for playing media i.e. the Multimedia Player 275.

At step 655, Multimedia Player 275 may access ODD 105 via Device Share Client 265, which communicates with device share server 210 to access Device Driver 205 directly. Multimedia Player 275 may thereby directly access ODD 105.

Client 125 continues playback of the media on ODD 105 until such time as a user concludes playback of the media. This may include, for example, pressing the stop button on the Multimedia Player 275, terminating (e.g., exiting) Multimedia Player 275 or terminating Media Library Client 280. Alternatively, the Request Broker in Disc Media Server 110 may monitor the locked ODD 105 for activity; unlocking the ODD 105 should client 125 fail to access ODD 105 for a pre-defined period of time.

Once the user concludes playback of the media, at step 660, client 125 may send a media release request to Disc Media Server 110. In response to the media release request, Disc Media Server 110 may unlock ODD 105, thereby making ODD 105 available for general use by any client 125. Furthermore, Disc Media Server 110 may also enable selection of the media in ODD 105 by clients.

Thereafter, the process ends at step 665.

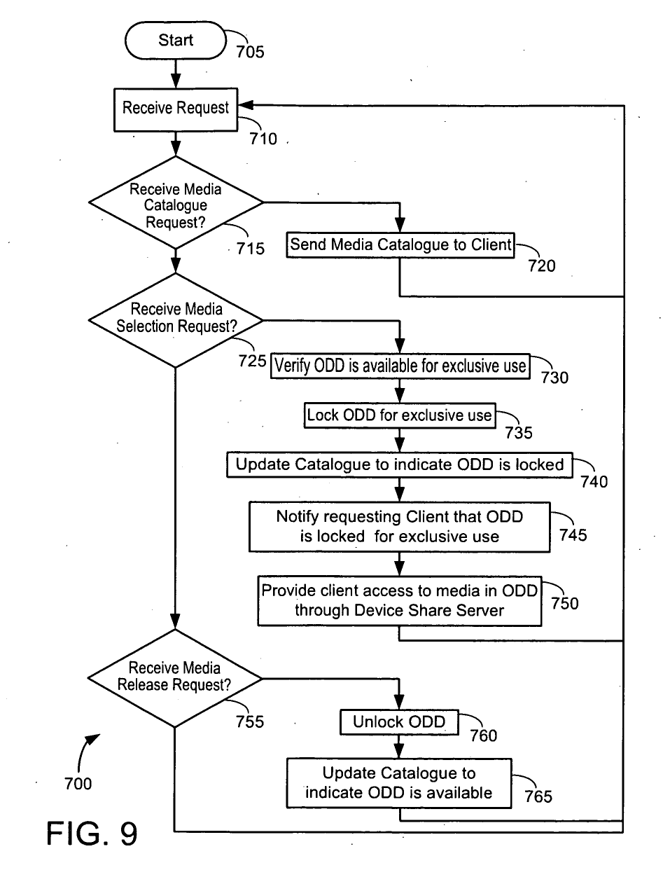

FIG. 9 illustrates a Disc Media Server Polling Process 700. Disc Media Server Polling Process 700 is a looping process performed by the Disc Media Server 110, which handles requests from client 125 on an ongoing basis.

This process begins at step 705, after the Disc Media Server 110 is initialized and connected to network 115.

At step 710, Disc Media Server 110 may receive a request from client 125.

At step 715 the media server determines whether the received request is a media catalog request. If the received request is a media catalog request, the process continues to step 720. If the received request is not a media catalog request, the process continues to step 725.

If the received request is a media catalog request, at step 720, Disc Media Server 110 sends a media library catalog to client 125. Within Disc Media Server 110, Network Controller 235 may route the media catalog request to Catalog Server 230. In response to the request, Catalog Server 230 may query the Media Catalogue Database 240 for the contents of the media library catalog and send a formatted response containing the media library catalog to client 125. Thereafter, process 700 may loop back to step 710.

If the received request is not a media catalog request, at step 725, Disc Media Server 110 determines whether the received request is a media selection request. If the received request is a media selection request, process 700 moves to step 730. If the received request is not a media selection request, then process 700 continues to step 755.

At step 730, Disc Media Server 110 identifies the ODD 105 associated with the selected media identified in the media selection request, and verifies that the ODD 105 associated with the selected media is available for exclusive use by the requesting client 125.

At step 735, Disc Media Server 110 locks ODD 105 for exclusive use by the requesting client 125.

At step 740, Disc Media Server 110 updates the catalog to indicate that ODD 105 is locked for exclusive use and disables selection of any media located in the locked ODD 105 from being selected by any other clients 125. This may include setting one or more flags within the media library catalog, indicating that the media in ODD 105 is unavailable.

At step 745, Disc Media Server 110 may notify the requesting client 125 that ODD 105 is locked for exclusive use by that client 125.

At step 750, the Catalog Server provides the client with access to the media in the optical disc drive 105 through the device share server 210.

If at step 725, the Disc Media Server 110 determines that the received request is not a media selection request, process 700 moves to step 755. At step 755, Disc Media Server 110 determines if the request is a media release request. If the request is a media release request, the Disc Media Server 110 unlocks the ODD 105 associated with the releasing client 125. The server 110 then updates the catalog to indicate that the media in ODD 105 is available for use and enables selection of the media contained in ODD 105 by any client requesting the media library catalog.

FIG. 10 illustrates an example embodiment of a user interface 800 provided by Metadata User Interface 260, at client 125. User interface 800 may employ any visual display technology including LCD monitors, touch screens, etc. User interface 800 may provide a display showing the available media 810 within the media library catalog. For example, in FIG. 10, the media library catalog may contain numerous movies. However, it will be appreciated that the contents of ODD 105 may include all forms of media, such as movies, audio, games, and data. User interface 800 allows a user to select one of the movies using a pointer 820. As pointer 820 traverses the selectable movies 810, the movie titles below the pointer 820 may be enlarged, highlighted, or otherwise emphasized. For example, the movie under pointer 820 may be emphasized by a larger icon, thicker borders, additional coloration, etc. Alternatively, the selectable movie may not be emphasized in any way. User Interface 800 may also include a scrolling mechanism 825 if the media library catalog is larger than the available display area 800. However, while the current interface includes example controls for selection and scrolling, various other implementations will fall within the scope of the disclosure.

FIG. 11 illustrates User Interface 800, where a client 125 has obtained exclusive use of an ODD 105. Similarly to FIG. 10, user interface 800 includes multiple selectable movies 810 and a pointer 820 for selecting movies from the available optical disc drives. However, unlike FIG. 10, FIG. 11 illustrates an example where certain media titles associated with ODD 105 are under exclusive use by another client 125. For example, movies 13, 14, 15, and 16 are disabled from active selection because they are currently under exclusive use by another client 125.

With regard to the processes, diagrams, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. Processes may also be implemented as computer-executable instructions (e.g., as one or more scripts), stored procedures, executable programs, etc. on a client, server, and/or database. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but instead with reference to the appended claims, along with the full scope of equivalents to which such claims are entitled. It is anticipated and intended that future developments will occur in the arts discussed herein, and that the mentioned systems and methods will be incorporated into such future embodiments. In sum, it should be understood that the invention is capable of modification and variation and is limited only by the following claims. While the foregoing disclosure shows illustrative embodiments of the invention, it should be noted that various changes and modifications could be made herein without departing from the scope of the invention as defined by the appended claims.

Computing devices (e.g., processors, clients, servers, terminals, etc.), such as those discussed herein generally may include executable instructions. Furthermore, processors may include any device itself containing any number of processing components, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. Computer-executable instructions may be compiled or interpreted from computer programs created using a variety of programming languages and/or technologies known to those skilled in the art, including, without limitation, and either alone or in combination, Java™, C, C++, assembly, etc. In general, a processor (e.g., a microprocessor), receives instructions (e.g., from a memory, a computer-readable medium, etc.), and executes these instructions, thereby performing one or more processes, including one or more of the processes described herein. Such instructions and other data may be stored and transmitted using a variety of known computer-readable media.

Databases or data stores described herein may include various kinds of mechanisms for storing, accessing, and retrieving various kinds of data, including a hierarchical database, a set of files in a file system, an application database in a proprietary format, a relational database management system (RDBMS), etc. Databases or data stores described herein may also store information on one or a plurality of computer readable mediums. Each such database or data store is generally included within a computing device employing a computer operating system, such as one of those mentioned above, and is accessed via a network in any one or more of a variety of manners, as is known. A file system may be accessible from a computer operating system, and may include files stored in various formats. An RDBMS generally employs the known Structured Query Language (SQL) in addition to a language for creating, storing, editing, and executing stored procedures, such as the PL/SQL language mentioned above.

A computer-readable medium includes any medium that participates in providing data (e.g., instructions), which may be read by a computer. Such a medium may take many forms, including, but not limited to, non-volatile media, volatile media, and transmission media. Non-volatile media include, for example, optical or magnetic discs and other persistent memory. Volatile media include dynamic random access memory (DRAM), which typically constitutes a main memory.

Communications between computing devices, and within computing devices, may employ transmission media including coaxial cables, copper wire, and fiber optics, including the wires that comprise a system bus coupled to the processor. Transmission media may include or convey acoustic waves, light waves, and electromagnetic emissions, such as those generated during radio frequency (RF) and infrared (IR) data communications. Common forms of computer-readable media include, for example, floppy discs, flexible discs, hard discs, magnetic tapes, any other magnetic media, a CD-ROM, DVD, any other optical media, punch cards, paper tapes, any other physical media with patterns of holes, RAM, PROM, EPROM, FLASH-EEPROM, any other memory chips or cartridges, carrier waves as described hereinafter, or any other medium from which a computer can read.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard discs, removable discs, a CD-ROM, or any other form of storage media known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., access terminal). In the alternative, the processor and the storage medium may reside as discrete components in a user terminal.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. Processes may also be implemented as computer-executable instructions (e.g., as one or more scripts), stored procedures, executable programs, etc. on a client, server, and/or database. In other words, the descriptions of processes herein are provided for the purpose of illustrating certain embodiments, and should in no way be construed so as to limit the claimed invention.

Thus embodiments of the present invention produce and provide a system and method for remote access of media on an optical disc. Although the present invention has been described in considerable detail with reference to certain embodiments thereof, the invention may be variously embodied without departing from the spirit or scope of the invention. Therefore, the following claims should not be limited to the description of the embodiments contained herein in any way.

1. A system for accessing multimedia on an optical disc in an optical disc drive from a remote location, comprising:
a multimedia server connected directly to the optical disc drive, the multimedia server comprising:
a cataloguing component that monitors the optical disc drive and maintains a multimedia catalogue, including updating the multimedia catalogue and providing the multimedia catalogue to a client, the multimedia catalogue including multimedia information identifying the multimedia in the optical disc drive;
a catalogue storage medium that stores the multimedia catalogue,
a drive state component that controls access to the optical disc drive and determines whether the optical disc drive is in a locked state or an available state, wherein, in the locked state, the optical disc drive is locked for exclusive use by a client;
a device server that provides the client direct access to the optical disc drive when the drive state component locks the optical disc drive for exclusive use by the client; and
a network connecting the multimedia server and the client.

2. The system of claim 1, wherein the client comprises:
a network interface for requesting the multimedia catalogue from the server;
a user interface for selecting multimedia from the multimedia catalogue and displaying the multimedia;
a playback component for playing the selected multimedia at the client; and
a remote access client for providing the multimedia playback component with direct access to the optical disc drive.

3. The system of claim 2, wherein the drive state component locks the optical disc drive for exclusive use by the client when the user selects multimedia from the multimedia catalogue corresponding to the optical disc in the optical disc drive.

4. The system of claim 3, wherein the drive state component unlocks the optical disc drive for exclusive use by the client when the playback component stops playing the selected multimedia data.

5. The system of claim 2, wherein, when the user selects multimedia from the multimedia catalogue corresponding to the optical disc in the optical disc drive, the cataloguing component disables selection of the multimedia, within the optical disc drive, by a second client.

6. The system of claim 5, wherein, when the playback component stops playing the selected multimedia, the cataloguing component enables selection of the multimedia, within the optical disc drive, by a second client.

7. The system of claim 2, wherein the remote access client communicates with the device server to communicate read operation commands to the optical disc drive and receive read operation output from the optical disc drive.

8. The system of claim 1, wherein the optical disc drive is a multi-disc changer containing a second optical disc.

9. The system of claim 8, wherein the multimedia catalogue includes multimedia information identifying the multimedia contained in the second optical disc in the optical disc drive.

10. The system of claim 8, wherein:
the server is directly connected to a second optical disc drive, the second optical disc drive containing a second optical disc, the second optical disc containing multimedia; and
the cataloguing component monitors the second optical disc drive and updates the multimedia catalogue with multimedia information identifying the multimedia in the second optical disc drive.

11. The system of claim 1, wherein the cataloguing component updates the multimedia information in the multimedia catalogue when any optical disc, containing multimedia, is removed from the optical disc drive or inserted into the optical disc drive.

12. The system of claim 1, wherein, when the optical disc is removed from the optical disc drive, the cataloguing component removes multimedia information, corresponding to the optical disc, from the multimedia catalogue.

13. The system of claim 1, wherein, when a second optical disc is inserted into the optical disc drive, the cataloguing component adds multimedia information, corresponding to the second optical disc, to the catalogue.

14. The system of claim 1, wherein updating the multimedia information in the multimedia catalogue includes obtaining title and content descriptions from a remote database.

15. A method for playing media from a remote location, comprising:
monitoring multimedia in an optical disc, the optical disc being in an optical disc drive connected directly to a server;
updating a multimedia catalog to include multimedia information identifying the multimedia;
providing the multimedia catalogue to a client;
controlling access to the optical disc drive by locking the optical disc drive for exclusive use by the client;
providing the client direct access to the optical disc drive, when the optical disc drive state component locks the optical disc drive for exclusive use by the client.

16. The method of claim 15, further comprising:
requesting the multimedia catalogue from the server;
displaying the multimedia catalogue at a client;
selecting multimedia from the multimedia catalogue at a client;
playing the contents of the selected multimedia data using a playback component at a client, wherein the playback component directly accesses the optical disc drive, connected to the server, using a remote access client.

17. The method of claim 16, wherein locking the optical disc drive for exclusive use by the client occurs after selecting multimedia from the multimedia catalogue.

18. The method of claim 17, further comprising unlocking the optical disc drive for exclusive use by the client, when the playback component stops playing of the selected multimedia.

19. The method of claim 16, further comprising disabling selection of the multimedia, within the optical disc drive, by a second client.

20. The method of claim 19, wherein, when the user stops playback of the selected multimedia data, enabling selection of the multimedia, within the optical disc drive, by a second client.

21. The method of claim 16, wherein the remote access client communicates with the device server to communicate read operation commands to the optical disc drive and receive read operation output from the optical disc drive.

22. The method of claim 15, wherein the optical disc drive is a multi-disc changer containing a second optical disc.

23. The method of claim 22, wherein the multimedia catalogue includes multimedia information identifying the multimedia contained in the second optical disc in the optical disc drive.

24. The method of claim 15, further comprising:
monitoring a second optical disc drive; and
updating the multimedia catalogue to include multimedia information identifying multimedia in an optical disc in the second optical disc drive;
wherein the server is directly connected to the second optical disc drive.

25. The method of claim 15, wherein updating the multimedia information in the multimedia catalogue includes updating the multimedia catalogue when any optical disc containing multimedia is removed from the optical disc drive or inserted into the optical disc drive.

26. The method of claim 15, further comprising removing multimedia information from the multimedia catalogue corresponding to the optical disc, when the optical disc is removed from the optical disc drive.

27. The method of claim 15, further comprising adding multimedia information to the multimedia catalogue corresponding to a second optical disc, when the second optical disc is inserted into the optical disc drive.

28. The method of claim 15, wherein updating the multimedia information in the multimedia catalogue includes obtaining title and content descriptions from a remote database.
